(19) United States
(12) Patent Application Publication
(10) Pub. No.: US 2010/0001986 A1
(43) Pub. Date: Jan. 7, 2010

(54) PLASMA DISPLAY DEVICE AND METHOD FOR DRIVING THE SAME

(75) Inventors: Taku Okada, Osaka (JP); Minoru Takeda, Osaka (JP); Yohei Koshio, Osaka (JP); Shinichiro Hashimoto, Osaka (JP); Kenji Ogawa, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/305,097

(22) PCT Filed: Apr. 4, 2008
(86) PCT No.: PCT/JP2008/000869

§ 371 Date: Dec. 16, 2008

(30) Foreign Application Priority Data
Apr. 18, 2007 (JP) 2007-108890

(51) Int. Cl. G09G 5/00; G09G 3/28

(52) U.S. Cl. 345/214; 345/60

(57) ABSTRACT

A method for driving a plasma display device which includes a plasma display panel provided with a plurality of discharge cells having a display electrode pair including a scan electrode and a sustain electrode, a temperature detection circuit for detecting an ambient temperature of the panel and outputting an detected temperature, and an APL detection circuit for detecting an APL of an image signal. The method provides an unusual-charge erasing period for applying a rectangular waveform voltage to the scan electrode between the initializing period and the address period in at least one subfield among the plurality of subfields; and controls a time period during which the rectangular waveform voltage is applied, based on the detected temperature detected by the temperature detection circuit and the APL detected by the APL detection circuit.

### TECHNICAL FIELD

The present invention relates to a plasma display device using a plasma display panel used in a wall-mounted television and a large-size monitor and a method for driving the same.

### BACKGROUND ART

An AC surface discharge panel as a typical plasma display panel (hereinafter, abbreviated as a “panel”) includes a front panel and a rear panel disposed facing each other with a large number of discharge cells provided therebetween.

The front panel has a plurality of display electrode pairs each including a pair of scan electrode and sustain electrode formed in parallel to each other on a front glass substrate, and has a dielectric layer and a protective layer formed so as to cover the display electrode pairs. The rear panel includes a plurality of data electrodes formed in parallel to each other on a rear glass substrate, a dielectric layer formed so as to cover the data electrodes, a plurality of barrier ribs formed in parallel to the data electrodes and on the dielectric layer, and a phosphor layer formed on the top surface of the dielectric layer and the side surface of the barrier rib.

The front panel and the rear panel are disposed facing each other so that the display electrode pairs three-dimensionally intersect with the data electrodes, and sealed to each other. The discharge space inside thereof is filled with a discharge gas including xenon. Herein, a discharge cell is formed in a portion where the display electrode pair and the data electrode face each other. In a panel having such a configuration, ultraviolet light is generated by gas discharge in each discharge cell, and this ultraviolet light excites phosphor layers to emit red, green and blue light. Thus, a color display is carried out.

As a method for driving a panel, a subfield method is generally employed. The subfield method divides one field into a plurality of subfields, and carries out gradation display by a combination of subfields to emit light.

Each subfield includes an initializing period, an address period, and a sustain period. In the initializing period, initializing discharge is generated and a wall charge necessary for a subsequent address operation is formed on each electrode. The initializing operation includes an initializing operation for generating an initializing discharge in all discharge cells (hereinafter, abbreviated as an “all-cell initializing operation”) and an initializing operation for generating initializing discharge in a discharge cell in which sustain discharge has been carried out (hereinafter, abbreviated as a “selective initializing operation”).

In the address period, address discharge is generated in a discharge cell to be displayed and a wall charge is formed. In the sustain period, a sustain pulse is applied to the display electrode pair including the scan electrode and the sustain electrode alternately so as to generate sustain discharge in a discharge cell in which address discharge has been generated. Then, a phosphor layer of the corresponding discharge cell is allowed to emit light so as to carry out an image display.

Furthermore, among the subfield methods, a new driving method is disclosed in which initializing discharge is carried out by using a gently changing voltage waveform, further an initializing discharge is selectively carried out with respect to a discharge cell in which sustain discharge has been carried out, and thereby light emission that is not related to a gradation display is reduced as much as possible so as to improve a contrast ratio (see, for example, patent document 1).

Specifically, for example, the all-cell initializing operation for discharging all discharge cells is carried out in the initializing period of one subfield in the plurality of subfields, and the selective initializing operation for initializing only a discharge cell in which sustain discharge has been generated is carried out in the initializing period of the other subfields. As a result, light emission that is not related to a display is only light emission accompanying the discharge in the all-cell initializing operation. Thus, an image display with a high contrast can be carried out.

However, according to such a driving method, since the number of all-cell initializing operations is limited, the initializing operation becomes unstable. As a result, an error operation occurs and sustain discharge is generated in a discharge cell in which address discharge has not been generated (hereinafter, abbreviated as “error lighting”). Therefore, a driving method for stabilizing initializing discharge by providing an unusual-charge erasing part in the all-cell initializing period is disclosed (see, for example, patent document 2).

Recently, with the trend toward larger size and higher definition of a panel, studies have been done in order to improve the light emission efficiency of the panel by increasing a partial pressure of xenon in a discharge gas filled in the panel. However, discharge tends to be further unstable, for example, the discharge delay is increased because discharge cells become finer or have higher efficiency. Then, when the initializing operation becomes unstable, the above-mentioned error lighting easily occurs, which may largely deteriorate the quality of the image display. Such a phenomenon tends to occur when a temperature of the panel is low.

[Patent document 1] Japanese Patent Application Unexamined Publication No. 2000-242224

[Patent document 2] Japanese Patent Application Unexamined Publication No. 2005-326612

### SUMMARY OF THE INVENTION

The present invention relates to a method for driving a plasma display device which includes a panel provided with a plurality of discharge cells each having a display electrode pairs each including a scan electrode and a sustain electrode, a temperature detection circuit for detecting an ambient temperature of the panel and outputting the detected temperature, and an APL detection circuit for detecting an APL of an image signal, wherein an image is displayed by forming one field by disposing a plurality of subfields each having an initializing period for generating initializing discharge in the discharge cell, an address period for generating address discharge in the discharge cell, and a sustain period for generating sustain discharge in the discharge cell. The method provides an unusual-charge erasing period for applying a rectangular waveform voltage to the scan electrode between the initializing period and the address period in at least one subfield among the plurality of subfields, and controls a time period during which the rectangular waveform voltage is applied based on the detected temperature detected by the temperature detection circuit and the APL detected by the APL detection circuit. With this method, it is possible to provide a method for driving a plasma display device that does not cause error lighting and not considerably deteriorate the quality of the image display in a wide temperature range.

Furthermore, in the method for driving a plasma display device in accordance with the present invention, it is desirable that the time period during which the rectangular waveform voltage is applied is controlled to be set longer when the detected temperature is low than when the detected temperature is high.

Furthermore, the present invention relates to a plasma display device including a panel provided with a plurality of discharge cells each having a display electrode pair including a scan electrode and a sustain electrode; a temperature detection circuit for detecting an ambient temperature of the panel and outputting the detected temperature; an APL detection circuit for detecting an APL of an image signal; and a panel drive circuit for displaying an image by forming one field by disposing a plurality of subfields each having an initializing period for generating initializing discharge in the discharge cell, an address period for generating address discharge in the discharge cell, and a sustain period for generating sustain discharge in the discharge cell. The panel drive circuit provides an unusual-charge erasing period for applying a rectangular waveform voltage to the scan electrode between the initializing period and the address period in at least one subfield among the plurality of subfields; and controls a time period during which the rectangular waveform voltage is applied based on the detected temperature detected by the temperature detection circuit and the APL detected by the APL detection circuit. With such a configuration, it is possible to provide a plasma display device that does not cause error lighting and not considerably deteriorate the quality of the image display in a wide temperature range.

### BRIEF DESCRIPTION OF THE DRAWINGS

FIG. 1 is an exploded perspective view showing a structure of a panel in accordance with an exemplary embodiment of the present invention.

FIG. 2 shows an arrangement of electrodes of the panel in accordance with an exemplary embodiment of the present invention.

FIG. 3 is a circuit block diagram showing a plasma display device in accordance with an exemplary embodiment of the present invention.

FIG. 4 shows drive voltage waveforms applied to each electrode of the panel in accordance with an exemplary embodiment of the present invention, which shows drive voltage waveforms in an all-cell initializing subfield.

FIG. 5 shows drive voltage waveforms in a selective initializing subfield that does not includes an unusual-charge erasing period.

FIG. 6 shows drive voltage waveforms in a selective initializing subfield that includes an unusual-charge erasing period.

FIG. 7 is a view showing a configuration of the subfields in accordance with an exemplary embodiment of the present invention.

FIG. 8 is a view showing time period TA and time period TB in accordance with an exemplary embodiment of the present invention.

FIG. 9 is a circuit diagram showing a scan electrode drive circuit in accordance with an exemplary embodiment of the present invention.

FIG. 10 is a timing chart to illustrate an operation of a scan electrode drive circuit in an unusual-charge erasing period in accordance with an exemplary embodiment of the present invention.

### REFERENCE MARKS IN THE DRAWINGS

10 panel
22 scan electrode
23 sustain electrode
24 display electrode pair
32 data electrode
40 panel drive circuit
41 image signal processing circuit
42 data electrode drive circuit
43 scan electrode drive circuit
44 sustain electrode drive circuit
45 timing generating circuit
46 temperature detection circuit
47 APL detection circuit
51 sustain pulse generating part
53 rising gradient voltage generating part
55 falling gradient voltage generating part
57 scan pulse voltage applying part
81 odd scan pulse generating part
86 even scan pulse generating part
90 composite switch part
100 plasma display device

### DETAILED DESCRIPTION OF THE PREFERRED EMBODIMENTS

Hereinafter, a plasma display device in accordance with an exemplary embodiment of the present invention is described with reference to drawings.

### Exemplary Embodiment

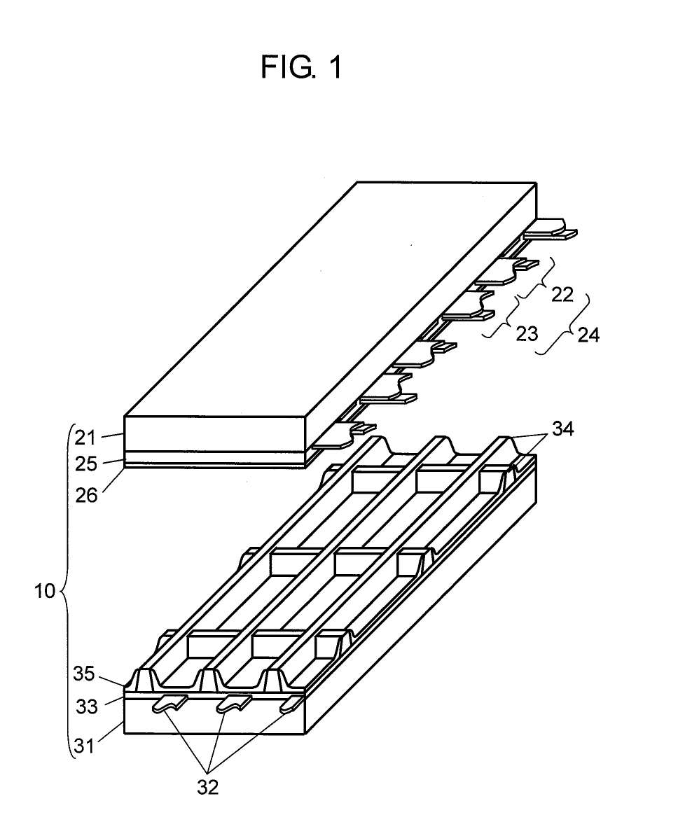

FIG. 1 is an exploded perspective view showing a structure of panel 10 in accordance with an exemplary embodiment of the present invention. A plurality of display electrode pairs 24 each including scan electrode 22 and sustain electrode 23 are formed on front glass substrate 21. Dielectric layer 25 is formed so as to cover scan electrode 22 and sustain electrode 23. Protective layer 26 is formed on dielectric layer 25. A plurality of data electrodes 32 are formed on rear substrate 31, dielectric layer 33 is formed so as to cover data electrodes 32, and double-cross-shaped barrier ribs 34 are formed further on dielectric layer 33. Phosphor layer 35 emitting red, green and blue light is provided on the side surface of barrier ribs 34 and on the top surface of dielectric layer 33.

Front substrate 21 and rear substrate 31 are disposed facing each other so that display electrode pairs 24 and data electrodes 32 intersect with each other with extremely small discharge space interposed therebetween. Front substrate 21 and rear substrate 31 are sealed to each other on the peripheral portions thereof with a sealing agent such as glass frit. For example, a mixture gas including neon and xenon as a discharge gas is filled in the discharge space. In this exemplary embodiment, in order to improve the brightness, a discharge gas having a partial pressure of xenon of 10% is used. The discharge space is partitioned into a plurality of sections by barrier ribs 34. A discharge cell is formed in a portion where display electrode pair 24 and data electrode 32 intersect with each other. These discharge cells are discharged and emit light, thereby displaying an image.

Note here that the structure of the panel is not necessarily limited to the above-mentioned structure and may include stripe-shaped barrier ribs.

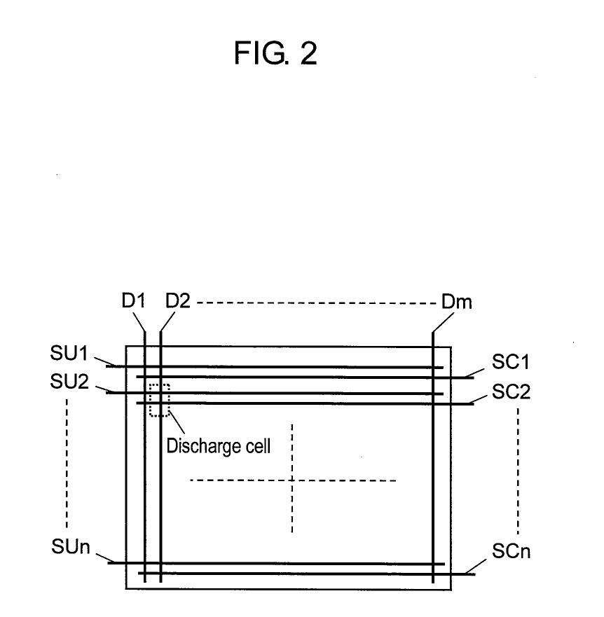

FIG. 2 shows an arrangement of electrodes of panel 10 in accordance with the exemplary embodiment of the present invention. On panel 10, n lines of scan electrodes SC1-SCn (scan electrodes 22 in FIG. 1) and n lines of sustain electrodes SU1-SUn (sustain electrodes 23 in FIG. 1), which are long in the row direction, are arranged, as well as m lines of data electrodes D1 to Dm (data electrodes 32 in FIG. 1) which are long in the column direction are arranged. In a portion where a pair of scan electrode SCi (i=1 to n) and sustain electrode SUi intersects with one data electrode Dj (j=1 to m), a discharge cell is formed. M×n pieces of the discharge cells are formed in discharge space. Note here that in the description of this exemplary embodiment, n is an even number. However, n may be an odd number.

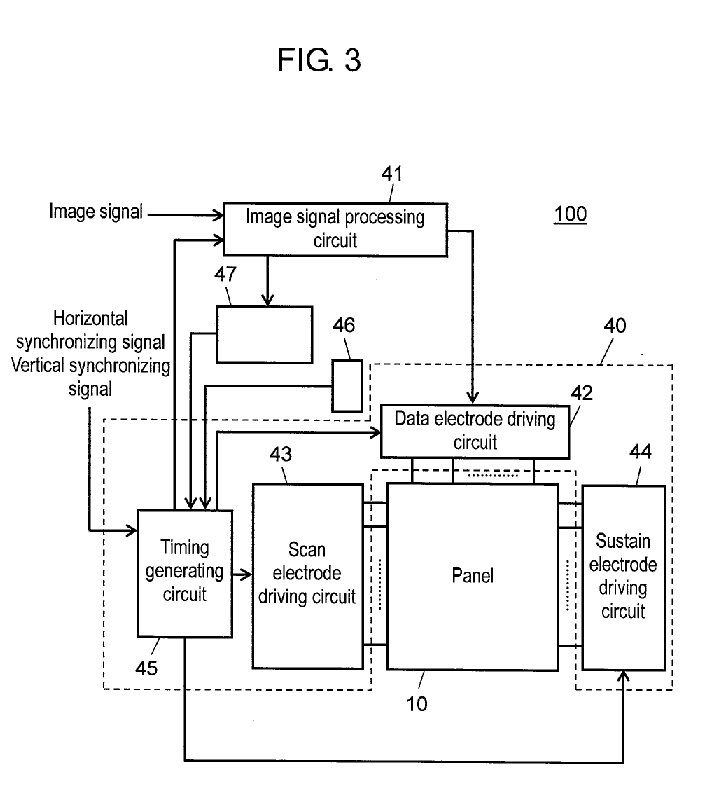

FIG. 3 is a circuit block diagram showing plasma display device 100 in accordance with an exemplary embodiment of the present invention. Plasma display device100 includes panel 10, panel drive circuit 40, image signal processing circuit 41, temperature detection circuit 46, APL detection circuit 47 and a power circuit (not shown) for supplying power source necessary for each circuit block. Panel drive circuit 40 has data electrode drive circuit 42, scan electrode drive circuit 43, sustain electrode drive circuit 44, and timing generating circuit 45.

Temperature detection circuit 46 includes a generally known thermally-sensitive element such as a thermistor and a thermocouple used for detecting a temperature, and detects the ambient temperature of panel 10.

Image signal processing circuit 41 converts an input image signal into image data showing light emission/light non-emission for every subfield. Data electrode drive circuit 42 converts image data for every subfield into a signal corresponding to each of data electrodes D1 to Dm so as to drive each of data electrodes D1 to Dm. APL detection circuit 47 detects an average brightness level (hereinafter, referred to as “APL”) of image signals. Specifically, the APL is detected by using a generally known technique, for example, a technique of accumulating brightness values of image signals for one field or one frame period.

Timing generating circuit 45 generates various timing signals for controlling an operation of each circuit based on a horizontal synchronizing signal, a vertical synchronizing signal and a detected temperature output from temperature detection circuit 46, and supplies the timing signals to each circuit. Scan electrode drive circuit 43 drives each of scan electrodes SC1 to SCn based on the timing signal. Sustain electrode drive circuit 44 drives sustain electrodes SU1 to SUn based on the timing signal.

Next, a drive voltage waveform for drive panel 10 and its operation are described. Plasma display device 100 displays gradation by a subfield method, in which one field is divided into plural subfields, and light emission/non-emission of each discharge cell is controlled for every subfield. Each subfield includes an initializing period, an address period, and a sustain period. In the exemplary embodiment, an unusual-charge erasing period is provided between the initializing period and the address period if necessary.

In the initializing period, initializing discharge is generated to form wall charge necessary for the subsequent address discharge. The initializing operation at this time includes an all-cell initializing operation and a selective initializing operation.

In the unusual-charge erasing period, a positive rectangular waveform voltage and a negative rectangular waveform voltage are applied to scan electrodes SC1 to SCn. If an initializing operation in the preceding all-cell initializing period becomes unstable and unusual charges accumulate in any of the discharge cells, the unusual charges in the discharge cell are erased in the unusual-charge erasing period.

In the address period, address discharge is generated to form a wall charge in a discharge cell to emit light. In the sustain period, the sustain pulses of the number corresponding to the brightness weight are alternately applied to display electrode pair 24, and sustain discharge is generated so as to emit light in the discharge cell in which address discharge has been generated.

Note here that the detail of the configuration of the subfield is described later. Herein, a drive voltage waveform in a subfield and its operation are described.

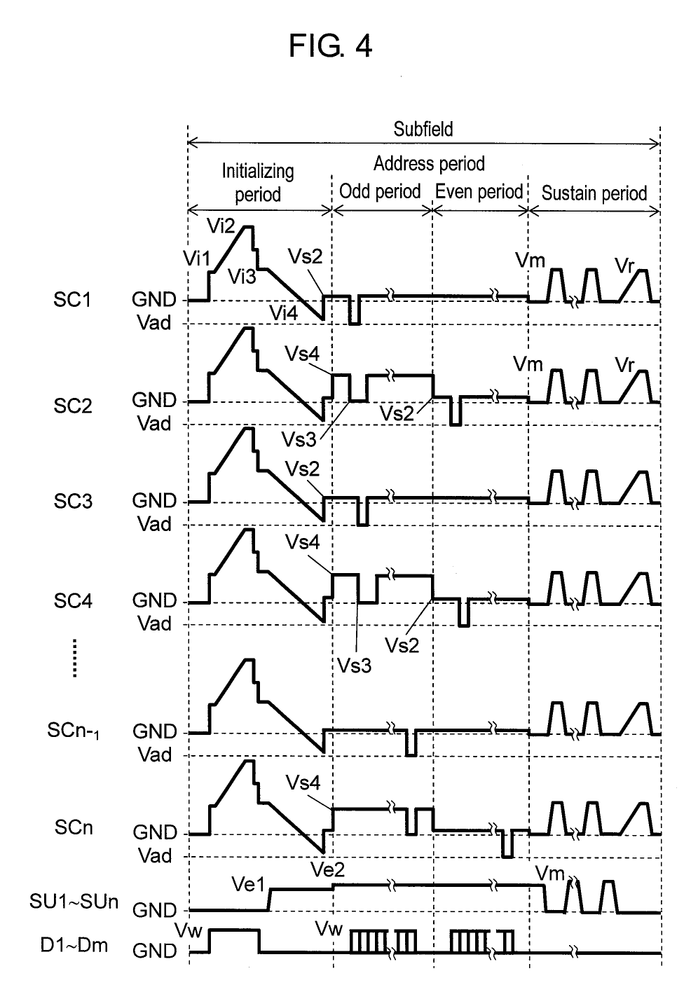

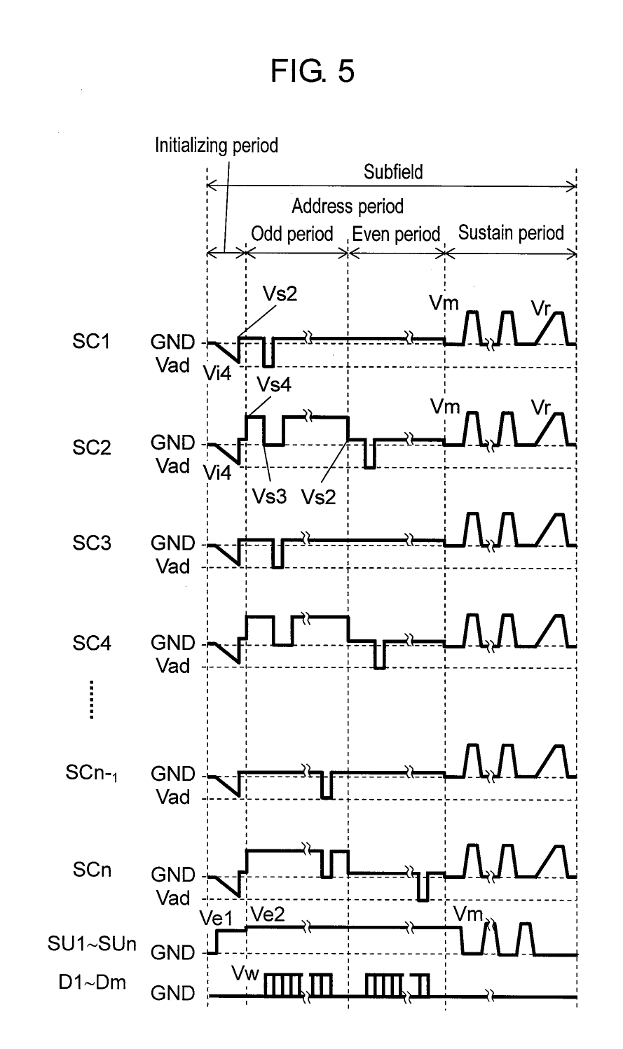

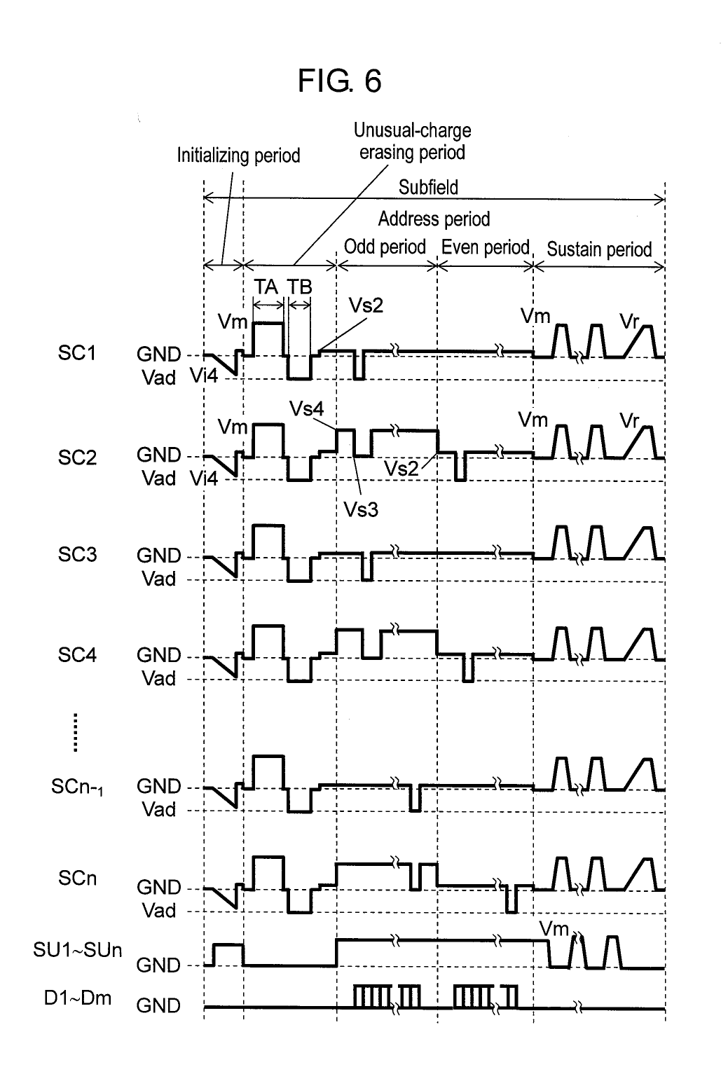

FIGS. 4, 5, and 6 show drive voltage waveforms applied to each electrode of panel 10 in accordance with an exemplary embodiment of the present invention. FIG. 4 shows a subfield in which an all-cell initializing operation is carried out (hereinafter, abbreviated as an “all-cell initializing subfield”) and which does not include an unusual-charge erasing period. FIG. 5 shows a subfield in which a selective initializing operation (hereinafter, abbreviated as a “selective initializing subfield”) and which does not includes an unusual-charge erasing period. FIG. 6 shows a selective initializing subfield that includes an unusual-charge erasing period.

Firstly, the all-cell initializing subfield that does not include an unusual-charge erasing period is described with reference to FIG. 4.

In the first half of the initializing period, address pulse voltage Vw is applied to data electrodes D1-Dm, a voltage of 0 (V) is applied to sustain electrodes SU1-SUn, and a gradient waveform voltage, gently rising from voltage Vi1 that is not higher than the discharge start voltage with respect to sustain electrodes SU1-SUn toward voltage Vi2 that is higher than the discharge start voltage, is applied to scan electrodes SC1-SCn.

While this gradient waveform voltage rises, feeble initializing discharge occurs between scan electrodes SC1-SCn and sustain electrodes SU1-SUn and between scan electrodes SC1-SCn and data electrodes D1-Dm, respectively. Then, a negative wall voltage accumulates on scan electrodes SC1-SCn, and a positive wall voltage accumulates on data electrodes D1-Dm and sustain electrodes SU1-SUn. Herein, the wall voltage on the electrode refers to a voltage generated by wall charges accumulated on the dielectric layer, the protective layer, the phosphor layer, and the like, covering the electrodes.

In the latter half of the initializing period, a voltage of 0 (V) is applied to data electrodes D1-Dm, positive voltage Ve1 is applied to sustain electrodes SU1-SUn, and a gradient waveform voltage, gently falling from voltage Vi3 that is not higher than the discharge start voltage with respect to sustain electrodes SU1-SUn toward voltage Vi4 that is higher than the discharge start voltage, is applied to scan electrodes SC1-SCn. During this time, feeble initializing discharge occurs between scan electrodes SC1-SCn and sustain electrodes SU1-SUn and between scan electrodes SC1-SCn and data electrodes D1-Dm, respectively. Then, the negative wall voltage on scan electrodes SC1-SCn and the positive wall voltage on sustain electrodes SU1-SUn are weakened, and the positive wall voltage on data electrodes D1-Dm is adjusted to a value suitable for an address operation. Thus, the all-cell initializing operation for carrying out initializing discharge with respect to all discharge cells is completed.

The above description relates to a case where an all-cell initializing operation is carried out normally. However, when discharge becomes unstable, for example, a discharge delay is increased, strong discharge may occur between scan electrodes SC1-SCn and data electrodes D1-Dm or between scan electrodes SC1-SCn and sustain electrodes SU1-SUn although a gently changing gradient waveform voltage is applied. Such a strong discharge is abbreviated as an “unusual initializing discharge.” When the unusual initializing discharge occurs in the latter half of the all-cell initializing period, a positive wall voltage accumulates on scan electrodes SC1-SCn, a negative wall voltage accumulates on sustain electrodes SU1-SUn, and some wall voltage accumulates on data electrodes D1-Dm. When the unusual initializing discharge occurs in the first half of the all-cell initializing period, the unusual initializing discharge occurs also in the latter half of the all-cell initializing period. As a result, the above-mentioned wall voltages accumulate. Since these wall voltages inhibit a normal operation of the discharge cell, a wall charge causing such a wall voltage is represented by an “unusual charge” hereinafter.

In the odd period in the subsequent address period, voltage Ve2 is applied to sustain electrodes SU1-SUn; second voltage Vs2 is applied to each of odd scan electrodes SC1, SC3, . . . , and SCn−1; and fourth voltage Vs4 is applied to each of even scan electrodes SC2, SC4, and SCn. Herein, fourth voltage Vs4 is a higher voltage than second voltage Vs2.

Next, in order to apply a negative scan pulse to first scan electrode SC1, scan pulse voltage Vad is applied. Then, positive address pulse voltage Vw is applied to data electrode Dk (k=1 to m) in the discharge cell to emit light in the first row among data electrodes D1-Dm. At this time, in this exemplary embodiment, third voltage Vs3 that is lower than fourth voltage Vs4 is applied to second scan electrode SC2, that is, a scan electrode neighboring scan electrode SC1. This is carried out in order to prevent too large voltage difference from being applied between the neighboring scan electrode SC1 and scan electrode SC2.

Then, a voltage difference in an intersection portion between on data electrode Dk and on scan electrode SC1 in a discharge cell in which address pulse voltage Vw has been applied results in the difference of the externally applied voltages (Vw−Vad) with the difference between the wall voltage on data electrode Dk and the wall voltage on scan electrode SC1 added. This voltage difference exceeds the discharge start voltage. Then, address discharge occurs between data electrode Dk and scan electrode SC1 and between sustain electrode SU1 and scan electrode SC1, a positive wall voltage accumulates on scan electrode SC1 and a negative wall voltage accumulates on sustain electrode SU1 and also on data electrode Dk. In this way, an address operation for generating address discharge in a discharge cell to emit light in the first row and accumulating a wall voltage on each electrode is carried out. On the other hand, a voltage in the intersection portion between data electrodes D1-Dm and scan electrode SC1, in which address pulse voltage Vw has not been applied, does not exceeds the discharge start voltage. Therefore, address discharge is not generated.

Since then, an address operation is similarly carried out with respect to the odd scan electrodes SC3, SC5, . . . , and SCn−1. At this time, third voltage Ve3 is applied also to even scan electrodes SCp and SCp+2 (p=even number, 1<p<n), that is, scan electrodes neighboring the odd scan electrode SCp+1 in which an address operation is carried out.

In the subsequent even period, while second voltage Vs2 is applied to odd scan electrodes SC1, SC3, . . . , and SCn−1, second voltage Vs2 is applied to even scan electrodes SC2, SC4, . . . , and SCn.

Next, in order to apply a negative scan pulse to second scan electrode SC2, scan pulse voltage Vad is applied. At the same time, positive address pulse voltage Vw is applied to data electrode Dk in the discharge cell to emit light in the second row among data electrodes D1-Dm. Then, a voltage difference in the intersection portion between on data electrode Dk and on scan electrode SC2 in the discharge cell exceeds the discharge start voltage. An address operation for generating address discharge in a discharge cell to emit light in the second row and accumulating a wall voltage on each electrode is carried out.

Since then similarly, the address operation is also carried out with respect to even scan electrodes SC4, SC6, . . . , and SCn.

Note here that since a discharge cell having an unusual charge does not have a wall voltage necessary for address discharge, normal address discharge is not generated.

In the subsequent sustain period, firstly, positive sustain pulse voltage Vm is applied to scan electrodes SC1-SCn and a voltage of 0 (V) is applied to sustain electrodes SU1-SUn. Then, in the discharge cell in which address discharge has been generated, a voltage difference between a voltage on scan electrode SCi and a voltage on sustain electrode SUi results in sustain pulse voltage Vm with a difference between wall voltage on scan electrode SCi and wall voltage on sustain electrode SUi added, which exceeds the discharge start voltage. Then, sustain discharge occurs between scan electrode SCi and sustain electrode SUi. Phosphor layer 35 emits light by ultraviolet light generated at this time. Thus, a negative wall voltage accumulates on scan electrode SCi and a positive wall voltage accumulates on sustain electrode SUi. In addition, a positive wall voltage accumulates also on data electrode Dk. In the discharge cell in which address discharge has not been generated in the address period, sustain discharge is not generated and the wall voltage at the end of the initializing period is maintained.

Subsequently, a voltage of 0 (V) is applied to scan electrodes SC1-SCn, and sustain pulse voltage Vm is applied to sustain electrodes SU1-SUn, respectively. Then, in the discharge cell in which sustain discharge has been generated, since a voltage difference between a voltage on sustain electrode SUi and a voltage on scan electrode SCi exceeds the discharge start voltage, sustain discharge occurs again between sustain electrode SUi and scan electrode SCi. Then, a negative wall voltage accumulates on sustain electrode SUi and a positive wall voltage accumulates on scan electrode SCi. In the same way since then, sustain pulses of the number corresponding to the brightness weight are applied alternately to scan electrodes SC1-SCn and sustain electrodes SU1-SUn so as to provide a potential difference between the electrodes of display electrode pair 24. Thus, sustain discharge is continued to be carried out in a discharge cell in which address discharge has been generated in the address period.

At the end of the sustain period, a gradient waveform voltage gently rising toward voltage Vr that is equal to or higher than sustain pulse voltage Vm is applied to scan electrodes SC1-SCn. Thus, the wall voltage on scan electrode SCi and the wall voltage on sustain electrode SUi are weakened with a positive wall voltage on data electrode Dk remained. Thus, the sustain operation in the sustain period is completed.

Note here that in the discharge cell having an unusual charge, since a positive wall voltage accumulates on scan electrode SCi and a negative wall voltage accumulates on sustain electrode SUi, sustain discharge may occur. However, since the unusual charge is not large enough to reliably generate sustain discharge, sustain discharge may occur accidentally. Furthermore, when sustain discharge is not generated in the first subfield, sustain discharge may occur in the sustain period of the next subfield. In this way, a discharge cell having an unusual charge can be always discharged when sustain pulse voltage Vm is applied to any of the electrodes of display electrode pair 24. However, when sustain discharge is generated in the sustain period, since an initializing operation is carried out normally in the initializing period following the sustain period, a normal operation is carried out in the subsequent subfields.

Next, an operation in a selective initializing subfield that does not include an unusual-charge erasing period is described with reference to FIG. 5.

In the initializing period in which a selective initializing operation is carried out, voltage Ve1 is applied to sustain electrodes SU1-SUn, and a voltage of 0 (V) is applied to data electrodes D1-Dm, respectively. A gradient waveform voltage gently falling from voltage 0 (V) toward voltage Vi4 is applied to scan electrodes SC1-SCn.

Then, feeble initializing discharge is generated in the discharge cell in which sustain discharge has been generated in the sustain period in a preceding subfield, and wall voltages on scan electrode SCi and on sustain electrode SUi are weakened. Furthermore, since sufficient positive wall voltages are accumulated on data electrode Dk by immediately preceding sustain discharge, an excessive portion of the wall voltages is discharged and the wall voltage is adjusted to a voltage suitable for address operation.

On the other hand, a discharge cell, in which sustain discharge has not been generated in the preceding subfield, is not discharged, and a wall charge at the end of the initializing period of the preceding subfield is maintained. In this way, the selective initializing operation is an operation for selectively carrying out initializing discharge with respect to a discharge cell in which a sustain operation has been carried out in the sustain period of the immediately preceding subfield.

Since an operation in a subsequent address period is the same as the operation in the address period of the all-cell initializing subfield, the description thereof is omitted. An operation in a subsequent sustain period is the same as that of the all-cell initializing subfield except for the number of sustain pulses.

Next, an operation of a selective initializing subfield including an unusual-charge erasing period is described with reference to FIG. 6. Since a selective initializing operation in the initializing period, an address operation in the address period and a sustain operation in the sustain period are the same as those in the selective initializing subfield that does not include an unusual-charge erasing period, respectively, the description thereof is omitted herein.

In the unusual-charge erasing period, while voltages of data electrodes D1-Dm are maintained at 0 (V), a positive rectangular waveform voltage, that is, rectangular waveform voltage Vm in this exemplary embodiment, is applied to scan electrodes SC1-SCn, and a voltage of 0 (V) is applied to sustain electrodes SU1-SUn. The voltage applied to each electrode at this time is the same as the voltage when first sustain pulse voltage Vm is applied to scan electrodes SC1-SCn in the sustain period. As mentioned above, in a discharge cell in which address discharge has not been generated, sustain discharge is not generated. However, since the unusual-charge erasing period is provided immediately after the initializing period and before the address period, in the normal discharge cell, discharge is not generated in the unusual-charge erasing period.

However, in a discharge cell having an unusual charge, since positive rectangular waveform voltage Vm is applied to scan electrodes SC1-SCn, discharge may occur. Furthermore, in this exemplary embodiment, a time period during which positive rectangular waveform voltage Vm is applied to scan electrodes SC1-SCn is set to be longer than a continuing time of the sustain pulse in the sustain period. Therefore, the possibility that a discharge cell having unusual charge is discharged during the unusual-charge erasing period is relatively higher as compared with the possibility that discharge is generated by a sustain pulse. Consequently, most discharge cells having unusual charges can be discharged in the unusual-charge erasing period.

Next, while the voltages of data electrodes D1-Dm and sustain electrodes SU1-SUn are maintained at 0 (V), a negative rectangular waveform voltage, that is, rectangular waveform voltage Vad in this exemplary embodiment, is applied to scan electrodes SC1-SCn. Then, a discharge cell having an unusual charge is discharged again so as to remove an unusual charge. Consequently, sustain discharge is not generated in the sustain period later. However, since a wall charge necessary for the address operation is also erased when an unusual charge is erased, an address operation also cannot be carried out. Such a state of wall charge is continued until the next all-cell initializing operation is carried out. In FIG. 6, a time period during which positive rectangular waveform voltage Vm is applied to scan electrodes SC1-SCn is denoted by time period TA, and a time period during which negative rectangular waveform voltage Vad is applied is denoted by time period TB.

Next, a configuration of the subfield in this exemplary embodiment is described. This exemplary embodiment is described assuming that one subfield is divided into ten subfields (first SF, second SF, . . . , and tenth SF) and the respective subfields have brightness weights of 1, 2, 3, 6, 11, 18, 30, 44, 60, and 80. However, the number of subfields and the brightness weight of each subfield are not limited to the above-mentioned values.

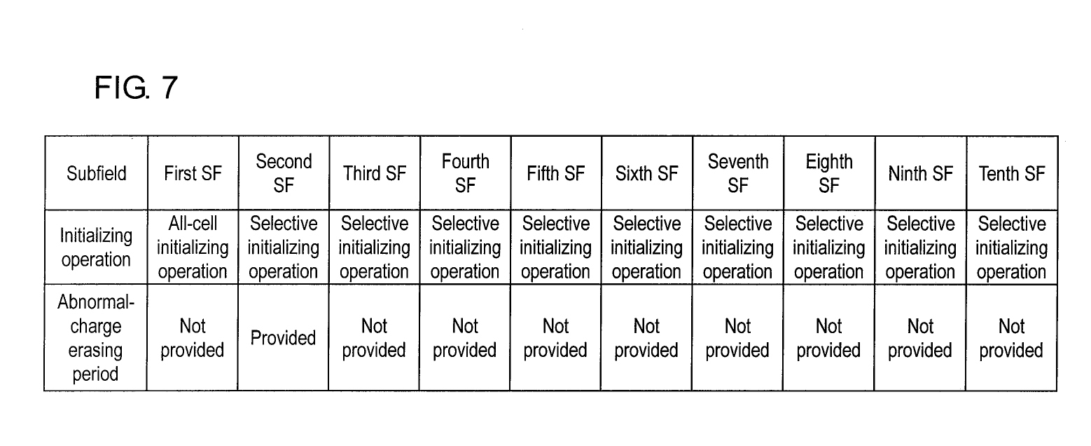

FIG. 7 shows configurations of the subfields in accordance with an exemplary embodiment of the present invention. In the exemplary embodiment of the present invention, the first SF is an all-cell initializing subfield, and the second to tenth SFs are selective initializing subfields. The second SF is provided with an unusual-charge erasing period and the other subfields are not provided with an unusual-charge erasing period.

As mentioned above, in a discharge cell having an unusual charge, sustain discharge may be accidentally generated in the sustain period of each subfield. Then, once sustain discharge is generated, the sustain discharge continues to the end of the sustain period. Therefore, light emission by this sustain discharge tends to be brighter in a subfield having a larger brightness weight, that is, in a subfield disposed later in this exemplary embodiment. If light is emitted brightly in a discharge cell that should not emit light, the quality of the image display is damaged largely. Therefore, light emission brightness by an unusual charge must be suppressed as much as possible. In order to do so, it is desirable that an unusual-charge erasing period is provided so as to an erase unusual charge in an early stage after the all-cell initializing operation. For such reasons, an unusual-charge erasing period is provided in the second SF in this exemplary embodiment.

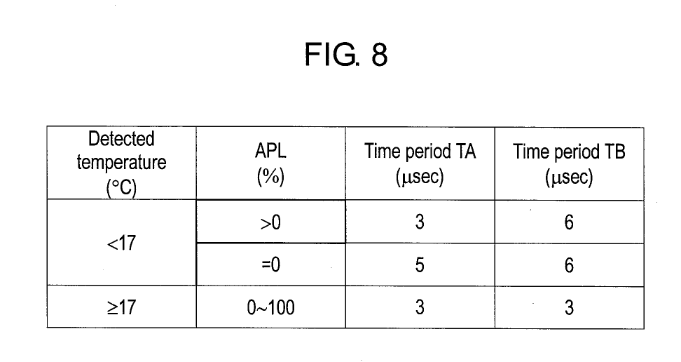

Furthermore, in this exemplary embodiment, driving is carried out by changing the lengths of time period TA and time period TB based on the detected temperature and APL. FIG. 8 shows time period TA and time period TB in accordance with an exemplary embodiment of the present invention. When the detected temperature is a temperature threshold value or more, since a discharge cell having an unusual charge can be discharged with a high possibility in the unusual-charge erasing period, a time period during which positive rectangular waveform voltage Vm is applied to scan electrodes SC1-SCn, that is, time period TA, is set to 3 μsec. Furthermore, a time period during which negative rectangular waveform voltage Vad is applied to scan electrodes SC1-SCn, that is, time period TB, is also set to 3 μsec. Then, almost all the discharge cells having an unusual charge can be discharged in the unusual-charge erasing period of the second SF.

On the other hand, when the detected temperature is less than a temperature threshold value, a discharge delay time becomes longer and the possibility of generating discharge is reduced. Thus, in this exemplary embodiment, time period TB is set to 6 μsec that is longer than that when a temperature is the temperature threshold value or more. In this way, when the detected temperature is less than the temperature threshold value, an unusual-charge erasing period is set to be longer and a discharge cell having an unusual charge is discharged in the unusual-charge erasing period in the subfield having as small brightness weight as possible, thereby preventing the deterioration of the quality of the image display.

In addition, in this exemplary embodiment, when the detected temperature is less than the temperature threshold value and APL is larger than 0, time period TA is set to 3 μsec. However, when the detected temperature is less than the temperature threshold value and APL is 0 or almost 0, time period TA is set to be as long as 5 μsec. This is carried out for the following reason. Error lighting generated when a black display is carried out or an extremely dark image is displayed tends to become remarkable, thus deteriorating the quality of image display significantly. Therefore, when the temperature is low and a discharge delay time is longer, not only time period TB but also time period TA is set to be long. Thus, error lighting in the dark screen is further suppressed.

In this exemplary embodiment, the predetermined temperature threshold value is, for example, 17° C. However, it is desirable that this value is suitably set based on the discharging characteristic of a panel, and the like. In this exemplary embodiment, the length of the unusual-charge erasing period is set by comparing the detected temperature with one temperature threshold value. However, by providing a plurality of temperature threshold values, the unusual-charge erasing period may be set to be shorter as the temperature is increased.

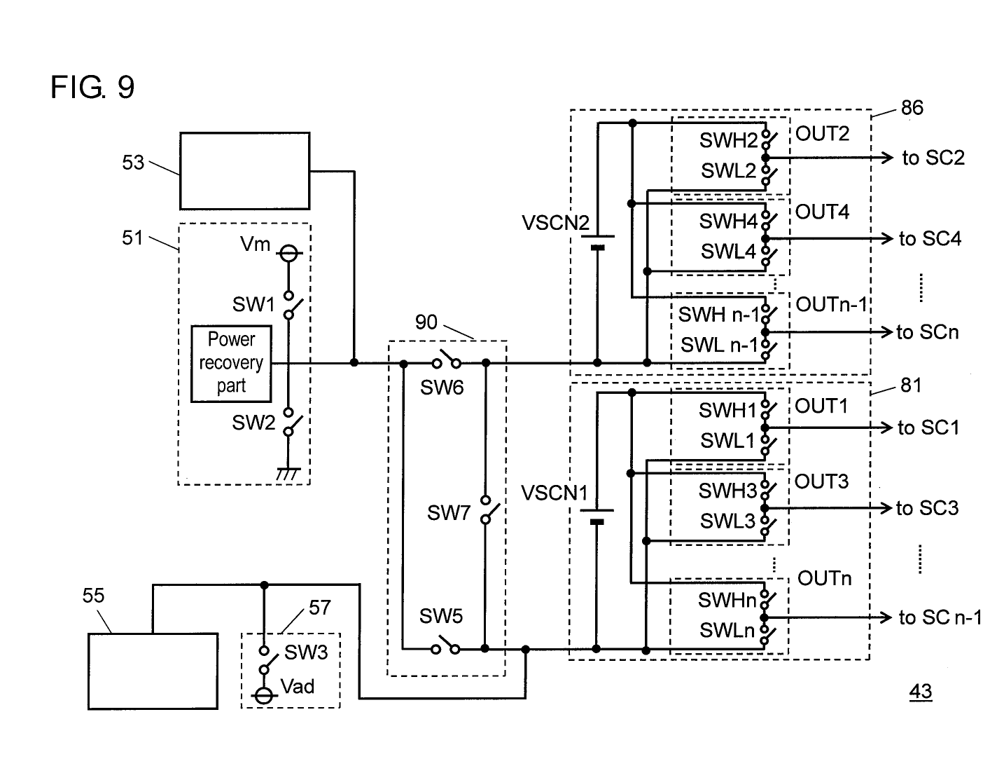

Next, a method for generating a drive voltage waveform in an unusual-charge erasing period is described. FIG. 9 is a circuit diagram showing scan electrode drive circuit 43 in accordance with an exemplary embodiment of the present invention. Scan electrode drive circuit 43 includes sustain pulse generating part 51, rising gradient voltage generating part 53, falling gradient voltage generating part 55, scan pulse voltage applying part 57, odd scan pulse generating part 81, even scan pulse generating part 86, and composite switch part 90.

Sustain pulse generating part 51 includes switching element SW1 for outputting sustain pulse voltage Vm, switching element SW2 for outputting a voltage of 0 (V), and a power recovery part for recovering electric power, and generates a sustain pulse to be applied to scan electrodes SC1-SCn in the sustain period. Rising gradient voltage generating part 53 generates a gently rising gradient waveform voltage to be applied to scan electrodes SC1-SCn in the first half of the initializing period.

Odd scan pulse generating part 81 includes floating power supply VSCN1 with voltage Vscn, and output parts OUT1, OUT3, and OUTn−1 for applying a reference voltage at the low voltage side or a voltage at the high voltage side of floating power supply VSCN1 to each of odd scan electrodes SC1, SC3, . . . , and SCn−1, respectively. Output parts OUT1, OUT3, . . . , and OUTn−1 includes switching elements SWH1, SWH3, . . . and SWHn−1 for outputting a voltage at a high voltage side of floating power supply VSCN1, and switching elements SWL1, SWL3, . . . , and SWLn−1 for outputting the reference voltage at the low voltage side of floating power supply VSCN1.

Even scan pulse generating part 86 similarly includes floating power supply VSCN2 with voltage of Vscn and output parts OUT2, OUT4, . . . , and OUTn for applying a reference voltage at the low voltage side or a voltage at the high voltage side of floating power supply VSCN2 to each of even scan electrodes SC2, SC4, . . . , and SCn. Output parts OUT2, OUT4, . . . , and OUTn include switching elements SWH2, SWH4, . . . , and SWHn for outputting a voltage at the high voltage side of floating power supply VSCN2 and switching elements SWL2, SWL4, . . . , and SWLn for outputting the reference voltage at the low voltage side of floating power supply VSCN2.

Scan pulse voltage applying part 57 has switching element SW3 and connects the reference voltage of odd scan pulse generating part 81 to scan pulse voltage Vad in the address period. Falling gradient voltage generating part 55 allows the reference voltage of odd scan pulse generating part 81 to gently fall in the latter half of the initializing period.

Composite switch part 90 includes switching element SW5 for connecting the reference voltage of odd scan pulse generating part 81 to the output of sustain pulse generating part 51 or rising gradient voltage generating part 53; switching element SW6 for connecting the reference voltage of even scan pulse generating part 86 to the output of sustain pulse generating part 51 or rising gradient voltage generating part 53; and switching element SW7 for connecting the reference voltage of odd scan pulse generating part 81 and the reference voltage of even scan pulse generating part 86 to each other.

Note here that floating power supply VSCN1 and floating power supply VSCN2 may be formed by using, for example, a DC-DC converter, etc., but can be easily formed by using a bootstrap circuit having a diode and a capacitor. In this exemplary embodiment, since a voltage of floating power supply VSCN1 and a voltage of floating power supply VSCN2 are voltage Vscn, second voltage Vs2 satisfies (Vs2=Vad+Vscn) and fourth voltage Vs4 satisfies (Vs4=Vs3+Vscn). Furthermore, voltage Vad is −140 (V), voltage Vscn is 148 (V), and third voltage Vs3 is 0 (V). However, these voltage values are just examples, it is desirable that voltages can be set to suitable values according to the property of a panel, and the like.

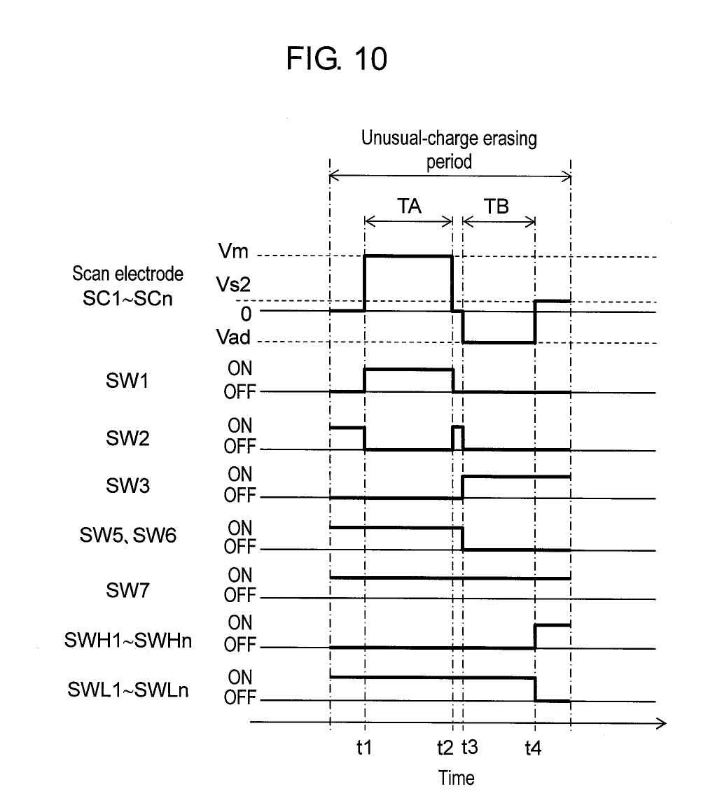

Next, an operation of scan electrode drive circuit 43 is described. FIG. 10 is a timing chart to illustrate an operation of scan electrode drive circuit 43 in an unusual-charge erasing period in accordance with an exemplary embodiment of the present invention. In the below mentioned description, an operation for making a switching element to be conductive is expressed by ON and an operation for blocking is expressed by OFF.

Firstly, a voltage of 0 (V) is assumed to be applied to scan electrodes SC1-SCn. Therefore, switching element SW2 of sustain pulse generating part 51, switching elements SW5 and SW6 of composite switch part 90, and switching elements SWL1-SWLn of output parts OUT1-OUTn are ON, and other switching elements are OFF.

At time t1, in sustain pulse generating part 51, switching element SW2 is turned OFF and switching element SW1 is turned ON. Then, voltage Vm is applied to scan electrodes SC1-SCn via switching element SW1, switching element SW5 or switching element SW6, and switching elements SWL1-SWLn.

At this time, in the discharge cell having an unusual charge, since a positive wall voltage accumulates on scan electrodes SC1-SCn and a negative wall voltage accumulates on sustain electrodes SU1-SUn, a voltage difference between on scan electrodes SC1-SCn and on sustain electrodes SU1-SUn exceeds the discharge start voltage and discharge is generated. Then, a negative wall voltage accumulates on scan electrodes SC1-SCn and a positive wall voltage accumulates on sustain electrodes SU1-SUn. Then, at time t2, in sustain pulse generating part 51, switching element SW1 is turned OFF and switching element SW2 is turned ON so as to return the voltage of scan electrodes SC1-SCn to 0 (V) once. Note here that a time period from t2 to t1 is a time during which positive rectangular waveform voltage Vm is applied to scan electrodes SC1-SCn, that is, time period TA.

Thereafter, at time t3, switching element SW2 is turned OFF, switching elements SW5 and SW6 of composite switch part 90 are turned OFF, switching element SW7 is turned ON, and furthermore, switching element SW3 of scan pulse voltage applying part 57 is turned ON. Then, voltage Vad is applied to scan electrodes SC1-SCn via switching element SW3 and switching elements SWL1-SWLn.

Then, in a discharge cell in which discharge is generated after time t1, a voltage difference between a voltage on scan electrodes SC1-SCn and a voltage on sustain electrodes SU1-SUn exceeds the discharge start voltage again, and discharge is generated. At this time, however, a voltage applied to sustain electrodes SU1-SUn is a voltage of 0 (V), and a voltage difference between a voltage on scan electrodes SC1-SCn and a voltage on sustain electrodes SU1-SUn does not much larger than the discharge start voltage. Therefore, wall voltages on scan electrodes SC1-SCn and sustain electrodes SU1-SUn are erased.

On the other hand, in a normal discharge cell in which an unusual charge is not accumulated, since only a voltage that is discharge start voltage or less is applied, discharge does not occur and a wall voltage at the end of the initializing period is maintained.

At time t4, switching elements SWL1-SWLn of output parts OUT1-OUTn are turned OFF and switching elements SWH1-SWHn are turned ON, and second voltage Vs2 is applied to scan electrodes SC1-SCn. Herein, second voltage Vs2 is a voltage obtained by superimposing voltage Vscn to scan pulse voltage Vad. Note here that a time period from t4 to t3 is a time during which negative rectangular waveform voltage Vad is applied to scan electrodes SC1-SCn, that is, time period TB. Following this, an address period starts.

Note here that the specific values and the like used in this exemplary embodiment are just examples, and suitable values are set desirably according to the property of a panel or the specification of a plasma display device, and the like.

### INDUSTRIAL APPLICABILITY

According to the present invention, since error lighting is not generated and the quality of the image display is not considerably deteriorated in a wide temperature range, the present invention is useful for a plasma display device and a driving method thereof.

1. A method for driving a plasma display device including:
a plasma display panel including a plurality of discharge cells each having a display electrode pair including a scan electrode and a sustain electrode;
a temperature detection circuit for detecting an ambient temperature of the plasma display panel and outputting the detected temperature; and
an APL detection circuit for detecting an APL of an image signal,
wherein an image is displayed by forming one field by disposing a plurality of subfields each having an initializing period for generating initializing discharge in the discharge cell, an address period for generating address discharge in the discharge cell, and a sustain period for generating sustain discharge in the discharge cell,
the method comprising:
providing an unusual-charge erasing period for applying a rectangular waveform voltage to the scan electrode between the initializing period and the address period in at least one subfield among the plurality of subfields; and
controlling a time period during which the rectangular waveform voltage is applied based on the detected temperature detected by the temperature detection circuit and the APL detected by the APL detection circuit.

2. The method for driving a plasma display device of claim 1, wherein the time period during which the rectangular waveform voltage is applied is controlled to be set longer when the detected temperature is low than when the detected temperature is high.

3. A plasma display device comprising:
a plasma display panel including a plurality of discharge cells each having a display electrode pair including a scan electrode and a sustain electrode;
a temperature detection circuit for detecting an ambient temperature of the plasma display panel and outputting the detected temperature;
an APL detection circuit for detecting an APL of an image signal; and
a panel drive circuit for displaying an image by forming one field by disposing a plurality of subfields each having an initializing period for generating initializing discharge in the discharge cell, an address period for generating address discharge in the discharge cell, and a sustain period for generating sustain discharge in the discharge cell,
wherein the panel drive circuit provides an unusual-charge erasing period for applying a rectangular waveform voltage to the scan electrode between the initializing period and the address period in at least one subfield among the plurality of subfields; and controls a time period during which the rectangular waveform voltage is applied based on the detected temperature detected by the temperature detection circuit and the APL detected by the APL detection circuit.

4. A method for driving a plasma display device, the device having a plasma display panel including a plurality of discharge cells, each one of the plurality of discharge cells having a display electrode pair including a scan electrode and a sustain electrode, the method comprising the steps of:
forming a field, the field comprised of a plurality of subfields;
providing for each one of the plurality of subfields an initializing period for generating initializing discharge in at least one of the plurality of discharge cells, an address period for generating address discharge in the at least one of the plurality of discharge cells, and a sustain period for generating sustain discharge in the at least one of the plurality of discharge cells;
providing an unusual-charge erasing period to the scan electrode for stabilizing the initializing discharge in the at least one of the plurality of discharge cells between the initializing period and the address period in at least one of the plurality of subfields; and
changing the length of the unusual-charge erasing period.

5. The method of claim 1, wherein the step of changing the length of the unusual-charge erasing period comprises:
detecting an ambient temperature of the plasma display panel; and
changing the length of the unusual-charge erasing period based on the ambient temperature of the plasma display panel.

6. The method of claim 1, wherein the step of changing the length of the unusual-charge erasing period comprises:
detecting an APL associated with an image signal; and
changing the length of the unusual-charge erasing period based on the APL.
